(19) United States
(12) Patent Application Publication
(10) Pub. No.: US 2026/0003134 A1
(43) Pub. Date: Jan. 1, 2026

(54) METHOD AND APPARATUS FOR FIXTURING A FERRULE OF A FIBER OPTIC CONNECTOR DURING END FACE MEASURING

(71) Applicant: CORNING RESEARCH & DEVELOPMENT CORPORATION, Corning, NY (US)

(72) Inventors: Alejandro Aguilar, Painted Post, NY (US); Kevin Eugene Elliott, Newton, NC (US); Benjamin Brian Young, Newton, NC (US)

(21) Appl. No.: 19/243,319

(22) Filed: Jun. 19, 2025

Related U.S. Application Data
(60) Provisional application No. 63/664,971, filed on Jun. 27, 2024.

(51) Int. Cl. G02B 6/38; G01M 11/00

(52) U.S. Cl. CPC G02B 6/385; G01M 11/30; G02B 6/3883; G02B 6/3885; G02B 6/3898

(57) ABSTRACT

A method of measuring an end face of a ferrule is disclosed. The ferrule defines at least a primary reference datum and a secondary reference datum. The method includes inserting the ferrule in a port of a fixture and securing the ferrule within the port of the fixture by imposing a first clamping force on the ferrule to engage the secondary reference datum with a first reference datum of the fixture, and subsequently imposing a second clamping force on the ferrule to engage the primary reference datum with a second reference datum of the fixture. Features of the end face of the ferrule may be measured while the ferrule is secured to the port of the fixture. A processing interface for securing a ferrule within a port of a fixture in a precise, predetermined location and a fixture having such a processing interface are also disclosed.

### PRIORITY APPLICATION

This application claims the benefit of priority of U.S. Provisional Application No. 63/664,971, filed on Jun. 27, 2024, the content of which is relied upon and incorporated herein by reference in its entirety.

### TECHNICAL FIELD

This disclosure relates generally to fiber optic connectivity, and more particularly to a method of securing a ferrule of a fiber optic connector in a predetermined location in a fixture during ferrule end face measuring, and to an apparatus for securing the ferrule to the fixture at the predetermined location prior to measuring the ferrule end face.

### BACKGROUND

Optical fibers are useful in a wide variety of applications, including the telecommunications industry for voice, video, and data transmissions. Benefits of optical fibers include wide bandwidth and low noise operation. In a telecommunications system that uses optical fibers, there are typically many locations where fiber optic cables containing the optical fibers connect to equipment or other fiber optic cables. To conveniently provide these connections, fiber optic connectors are often provided on the ends of fiber optic cables to non-permanently connect and disconnect optical elements in the fiber optic network. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

The introduction of fiber optic connectors, however, may introduce insertion losses across an optical connection, e.g., at the junction between two or more optical fibers. One common optical connection in a network is one between two mated fiber optic connectors. It should be recognized, however, that the term “optical connection” may encompass other types of junctions between optical fibers. The insertion losses in coupling two optical fibers across an optical connection are generally a function of the alignment of the optical fiber ends, the width of the gap between the ends, and the optical surface condition at the ends. To minimize insertion losses, processes have been developed for reducing misalignments of the optical fibers across the optical connection and for optimizing the geometry and cleanliness of the optical fiber end faces.

A fiber optic connector typically includes a ferrule having one or more bores for receiving the optical fibers carried by the fiber optic cable. The ferrule holds the ends of the optical fibers and includes a ferrule end face for presentation of the ends of the optical fibers for optically communicating with corresponding optical fibers across the optical connection. The fiber optic connector further includes a connector housing assembly (also referred to as a connector body) which is configured to receive the ferrule within the housing assembly. The connector housing assembly is configured to mate with an optical device (e.g., adapter, equipment port, etc.) so that the ferrule, and more particularly the end faces of the one or more optical fibers received therein, is accurately positioned at a predetermined location. The optical fibers across the connection interface are similarly accurately positioned at a predetermined location such that misalignments of the optical fibers across the optical connection, and the resulting insertion losses, are minimized.

As noted above, misalignments of the optical fibers across the optical connection may be due to deviations in the desired geometry of the ferrule end faces. Ferrules of fiber optic connectors are subject to several manufacturing processes to form an operative fiber optic connector, including ferrule body formation, fiber bore formation, fiber insertion and securement processes, guide pin processes, end face shaping processes, end face polishing processes, etc. Any number of these various processes may introduce a deviation in the desired end face state (e.g., geometry, cleanliness, etc.) of the ferrule. To ensure high quality fiber optic connections across an optical connection, it can be important to verify the quality of the ferrule end face geometry. To this end, it is common in the telecommunications industry to inspect and measure the end faces of ferrules to ensure the end face geometry conforms to the desired geometry. Such measurement equipment is well known in the telecommunications industry and includes various types of interferometers, microscopes, and/or other metrology instrumentation.

As noted above, it is important that the connectorization process precisely provide the desired geometry of the ferrule/fiber end faces. Indeed, in many cases, the optical fiber and ferrule end faces must conform to relevant industry standards that specify requirements for different physical contact geometries. Examples of physical contact geometries known in the industry include, but are not limited to, physical contact (PC), angled physical contact (APC), and ultra physical contact (UPC) geometries. Thus, the challenge is to consistently provide ferrule end face geometries that conform to the industry standards. Measurement testing of ferrule end face geometries provides that assurance that standards in ferrule geometries are being met.

Various ferrule measuring fixtures have been developed to fixate or hold the ferrule in a precise and predetermined location relative to the fixture when measuring the end face geometry of the ferrules. Such fixtures typically include a port that receives the ferrule and a clamp arrangement that applies forces to the ferrule in order to secure the ferrule at the predetermined location within the port of the fixture. In this regard, the fixture port typically includes a plurality of reference datums that engage with corresponding reference datums on the ferrule when acted upon by the clamp arrangement. Once the ferrule is securely clamped in its precise, predetermined location within the port of the fixture, measuring the end face geometry of the ferrule may commence. The forces imposed by the clamp arrangement on the ferrule must be of sufficient magnitude to prevent the ferrule from moving within the port and away from its predetermined location during measuring.

While current measurement fixtures are generally successful for current ferrule designs, the continued reduction in size of optical fibers, fiber optic cables, and fiber optic connectors, including ferrules of the fiber optic connectors, presents certain challenges in fixturing the ferrules during end face measuring. In this regard, due to their decreased size, the ferrules for more recent very small form factor fiber optic connectors are difficult to accurately clamp, and therefore difficult to position in a precise, predetermined location within the port of the fixture. Because in many cases the ferrule is not precisely positioned within the port, the measurement process will reject an otherwise “good” ferrule end face geometry or possibly accept an otherwise “bad” end face geometry. This, in turn, may lead to an unnecessary increase in scrap or waste, or place into operation a fiber optic connector with high insertion losses across the optical connection.

In view of the above, there is a need in the telecommunications industry for a fixture having a clamp arrangement that consistently and precisely secures very small form factor ferrules within its port at predetermined locations. There is also a need for a method of securing very small form factor ferrules in predetermined locations within the port of the fixture.

### SUMMARY

In one aspect of the disclosure, a method of measuring an end face of a ferrule of a fiber optic connector is disclosed. The ferrule defines at least two reference datums, one of the at least two reference datums being a primary reference datum and another of the at least two reference datums being a secondary reference datum. The method includes inserting the ferrule in a port of a fixture and securing the ferrule within the port of the fixture. The step of securing the ferrule within the port of the fixture includes imposing a first clamping force (F₁) on the ferrule to engage the secondary reference datum of the ferrule with a first reference datum associated with the fixture, and subsequently imposing a second clamping force (F₂) on the ferrule to engage the primary reference datum of the ferrule with a second reference datum associated with the fixture. The method further includes measuring features of the end face of the ferrule while the ferrule is secured to the port of the fixture.

In one embodiment, imposing the first clamping force (F₁) on the ferrule may include imposing the first clamping force (F₁) with a first magnitude (M₁) and imposing the second clamping force (F₂) on the ferrule may include imposing the second clamping force (F₂) with a second magnitude (M₂), where the second magnitude (M₂) is greater than the first magnitude (M₁). In one embodiment, imposing the first clamping force (F₁) on the ferrule may further include activating a first clamp mechanism and imposing the second clamping force (F₂) on the ferrule may further include activating a second clamp mechanism, where the first clamp mechanism and the second clamp mechanism are separate from each other and independently controlled. In one embodiment, imposing the first clamping force (F₁) on the ferrule may further include imposing a first spring force on the ferrule and imposing the second clamping force (F₂) on the ferrule may further include imposing a second spring force on the ferrule.

In one embodiment, the at least two reference datums of the ferrule may further include a tertiary reference datum. In this embodiment, the method may further include imposing a third clamping force (F₃) on the ferrule to engage the tertiary reference datum of the ferrule with a third reference datum associated with the fixture. In one embodiment, imposing the third clamping force (F₃) on the ferrule may include imposing the third clamping force (F₃) on the ferrule prior to imposing the first clamping force (F₁) on the ferrule. In one embodiment, imposing the third clamping force (F₃) on the ferrule may include imposing the third clamping force (F₃) with a third magnitude (M₃), where the third magnitude (M₃) is less than the first magnitude (M₁). In one embodiment, imposing the third clamping force (F₃) on the ferrule may further include activating a third clamp mechanism. In one embodiment, imposing the second clamping force (F₂) on the ferrule and imposing the third clamping force (F₃) on the ferrule may further include activating a same clamp mechanism to impose both the second clamping force (F₂) and the third clamping force (F₃) on the ferrule. In one embodiment, imposing the third clamping force (F₃) on the ferrule may include imposing a third spring force on the ferrule.

In one embodiment, the ferrule may include a generally rectangular ferrule body defining a top surface, a bottom surface, opposed side surfaces, a front end face, and a rear end face. The plurality of fiber bores extends between the rear end face and the front end face. In one embodiment, the ferrule may further include a cavity in the top surface of the ferrule body that extends from the front end face toward the rear end face for part of a length of the ferrule, the cavity being open to the front end face of the ferrule body and including opposed side walls and a rear wall. The cavity also extends from the top surface toward the bottom surface for part of a height of the ferrule body. In this embodiment, the top surface of the ferrule body may serve as the primary reference datum and the rear wall of the cavity in the top surface may serve as the secondary reference datum.

In a second aspect of the disclosure, a fixture for measuring an end face of a ferrule of a fiber optic connector is disclosed. The ferrule defines at least two reference datums, one of the at least two reference datums being a primary reference datum and another of the at least two reference datums being a secondary reference datum. The fixture includes a fixture port configured to receive the ferrule therein and a plurality of clamp mechanisms for clamping the ferrule within the port in a predetermined location. The plurality of clamp mechanisms is configured to impose a first clamping force (F₁) on the ferrule to engage the secondary reference datum of the ferrule with a first reference datum associated with the fixture and subsequently impose a second clamping force (F₂) on the ferrule to engage the primary reference datum of the ferrule with a second reference datum associated with the fixture.

In one embodiment, the plurality of clamp mechanisms may include a first clamp mechanism for imposing the first clamping force (F₁) on the ferrule and a second clamp mechanism for imposing the second clamping force (F₂) on the ferrule, where the first clamp mechanism and the second clamp mechanism are separate from each other and independently controlled. In one embodiment, the first clamp mechanism may include an actuator arm movable along an actuator axis between an extended position and a retracted position and a headpiece connected to an end of the actuator arm. In the extended position, the headpiece is configured to contact the ferrule and clamp the ferrule to the port of the fixture in the predetermined position, and in the retracted position, the headpiece is configured to be in non-contact relation with the ferrule. In one embodiment, the headpiece may include at least one spring arm such that the first clamping force (F₁) is a spring force.

In one embodiment, the fixture may include a processing interface that defines the port for receiving the ferrule. The processing interface may include a processing body defining an aperture and a primary flexure element moveably disposed in the aperture. The port is defined at least in part by the processing body and at least in part by the primary flexure element, and the second clamp mechanism may be operatively connected to the primary flexure element for moving the primary flexure element between an opened position, in which the ferrule is insertable in the port, and a closed position, in which the ferrule is secured in the port.

In one embodiment, the primary flexure element may include a primary spring arm and a primary flexure head connected to the primary spring arm. In one embodiment the primary flexure element, and more particularly the primary flexure head, may include a secondary flexure element, where the secondary flexure element is the portion of the primary flexure element that defines at least part of the port. In one embodiment, the secondary flexure element may include a secondary spring arm and a secondary flexure head connected to the secondary spring arm, where the secondary flexure head is the portion of the secondary flexure element that defines at least part of the port. In one embodiment, the secondary flexure head may include a first leg having a first projection configured to engage with the ferrule and a second leg connected to the first leg and having a second projection configured to engage with the ferrule. In one embodiment, the second projection may include a chamfer that defines a ridge for engaging with the ferrule. In one embodiment, the primary flexure element may include at least one spring arm such that the second clamping force (F₂) is a spring force.

In one embodiment, the processing body may have an engagement region including a first edge that defines a first shoulder for engaging with the ferrule and a second edge that defines at least one projection for engaging with the ferrule. In one embodiment, the first shoulder may include a chamfer that defines a ridge for engaging with the ferrule. In one embodiment, the second edge of the processing body may further include a second shoulder and a third shoulder on opposed sides of the at least one projection for engaging with the ferrule.

In one embodiment, the plurality of clamp mechanisms is configured to impose the first clamping force (F₁) with a first magnitude (M₁) and impose the second clamping force (F₂) with a second magnitude (M₂), where the second magnitude (M₂) is greater than the first magnitude (M₁). In one embodiment, the at least two reference datums of the ferrule may further include a tertiary reference datum. The plurality of clamp mechanisms is configured to impose a third clamping force (F₃) on the ferrule. In one embodiment, the second clamp mechanism may be configured to impose the second clamping force (F₂) on the ferrule and impose the third clamping force (F₃) on the ferrule. In one embodiment, the plurality of clamping mechanisms is configured to impose the third clamping force (F₃) with a third magnitude (M₃) that is less than the first magnitude (M₁). In one embodiment, the primary flexure element may include at least one spring arm such that the third clamping force (F₃) is a spring force.

In another aspect of the disclosure, a processing interface of a fixture for measuring an end face of a ferrule of a fiber optic connector is disclosed. The processing interface defines a port for receiving the ferrule and includes a processing body that defines an aperture and a primary flexure element movably disposed in the aperture. The port is defined at least in part by the processing body and at least in part by the primary flexure element. A clamp mechanism is configured to be operatively connected to the primary flexure element for moving the primary flexure element between an opened position, in which the ferrule is insertable in the port, and a closed position, in which the ferrule is secured in the port.

In one embodiment, the primary flexure element may include a primary spring arm and a primary flexure head connected to the primary spring arm. In one embodiment, the primary flexure element, and more particularly the primary flexure head, may include a secondary flexure element, wherein the secondary flexure element is the portion of the primary flexure element that defines at least part of the port. In one embodiment, the secondary flexure element may include a secondary spring arm and a secondary flexure head connected to the secondary spring arm, where the secondary flexure head is the portion of the secondary flexure element that defines at least part of the port. In one embodiment, the secondary flexure head may include a first leg having a first projection configured to engage with the ferrule and a second leg connected to the first leg having a second projection configured to engage with the ferrule. In one embodiment, the second projection may include a chamfer that defines a ridge for engaging with the ferrule. In one embodiment, the primary flexure element may include at least one spring arm such that the second clamping force (F₂) is a spring force.

In one embodiment, the processing body may have an engagement region including a first edge that defines a first shoulder for engaging with the ferrule and a second edge that defines at least one projection for engaging with the ferrule. In one embodiment, the first shoulder may include a chamfer that defines a ridge for engaging with the ferrule. In one embodiment, the second edge of the processing body may further include a second shoulder and a third shoulder on opposed sides of the at least one projection for engaging with the ferrule.

In yet another aspect of the disclosure, a method of making a fiber optic cable assembly is disclosed. The method includes stripping an end of a fiber optic cable carrying a plurality of optical fibers to expose a length of the optical fibers, loading one or more components of a fiber optic connector onto the stripped end of the fiber optic cable, securing the optical fibers to a ferrule of the fiber optic connector, and measuring an end face of the ferrule according to the first aspect described above. In one embodiment, the method may include polishing the end face of the ferrule before measuring the end face of the ferrule.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of a fiber optic cable assembly having a fiber optic cable terminated by an MMC fiber optic connector.

FIG. 2 is a disassembled perspective view of the MMC fiber optic connector shown in FIG. 1.

FIG. 3 is a disassembled perspective view of the crimp body of the MMC fiber optic connector shown in FIGS. 1 and 2.

FIG. 4 is a perspective view of a very small form factor ferrule in the form of a TMT ferrule with fiber optic cables connected thereto.

FIG. 5 is an enlarged perspective view of the TMT ferrule shown in FIG. 4.

FIG. 6 is an exemplary method for securing a workpiece within a processing fixture in accordance with an embodiment of the disclosure.

FIG. 7 is a rear plan view of a processing interface of a fixture in accordance with an embodiment of the disclosure.

FIG. 8 is an enlarged rear plan view of a portion of the processing interface of the fixture shown in FIG. 7.

FIG. 9 is a side view of the processing interface indicated generally by line 9-9 shown in FIG. 8.

FIG. 10 is a side view of the processing interface indicated generally by line 10-10 shown in FIG. 8.

FIG. 11 is a rear plan view of a ferrule in the port of the fixture when a second clamp mechanism is in the opened position.

FIG. 12 is a rear plan view of a ferrule in the port of the fixture when the second clamp mechanism is in the closed position.

FIG. 13 is a rear cross-sectional view of the ferrule in the port of the fixture when the second clamp mechanism is in the closed position.

FIG. 14 is a rear cross-sectional view of the ferrule in the port of the fixture when the second clamp mechanism is in the closed position in accordance with another embodiment of the disclosure.

FIG. 15 is a rear plan view of the ferrule in the port of the fixture when the second clamp mechanism is in the opened position and the first clamp mechanism is in the retracted position.

FIG. 16 is a rear plan view of the ferrule in the port of the fixture when the second clamp mechanism is in the closed position and the first clamp mechanism is in the extended position.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure. In general, the description relates to a method of consistently and precisely positioning a ferrule of a fiber optic connector in a predetermined location in a port of a measuring fixture. The ferrule includes at least two reference datums, one of which operates as the primary reference datum for the ferrule and another of which operates as the secondary reference datum for the ferrule. The method includes clamping the ferrule in the port of the fixture by: i) engaging the secondary reference datum with a corresponding reference datum in the port of the fixture; and ii) engaging the primary reference datum with a corresponding reference datum in the port of the fixture. In other words, securing of the ferrule in the port of the fixture has a specific sequence as it relates to the primary and secondary reference datums of the ferrule, i.e., the secondary reference datum is engaged with the port prior to the primary reference datum being secured to the port. Additionally, further advantages may be gained through a specific sequencing of the magnitudes of the clamping forces imposed on the ferrule. In this regard, certain advantages may be gained by engaging the secondary reference datum to the port of the fixture with a magnitude in the clamping force that is less than the magnitude of the clamping force in which the primary reference datum is engaged to the port of the fixture. In other words, the magnitudes of the clamping forces used to secure the ferrule to the port of the fixture may also have a specific sequence as it relates to the primary and secondary reference datums of the ferrule. These and other aspects of the present disclosure are described in more detail below.

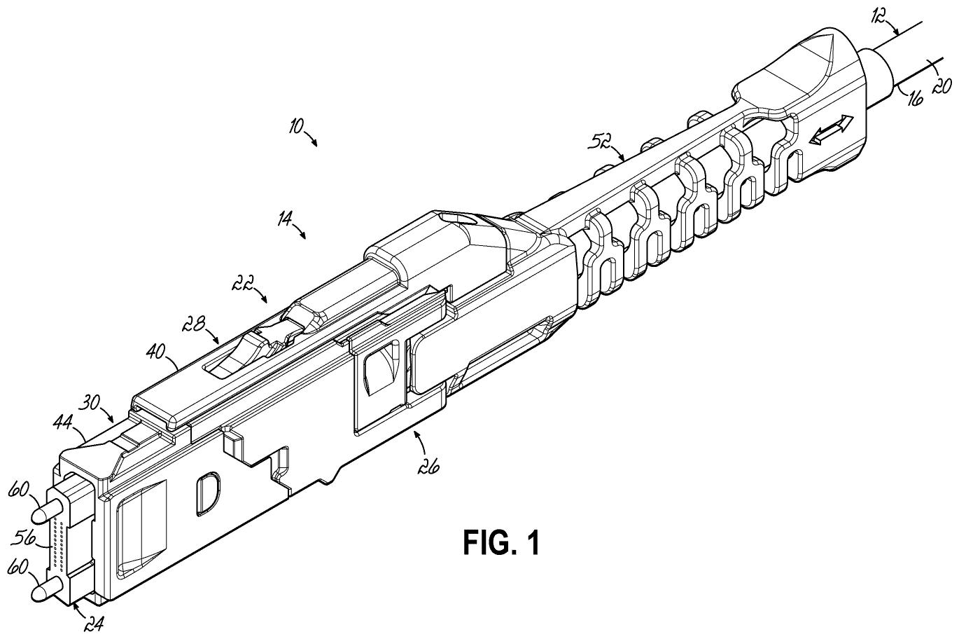

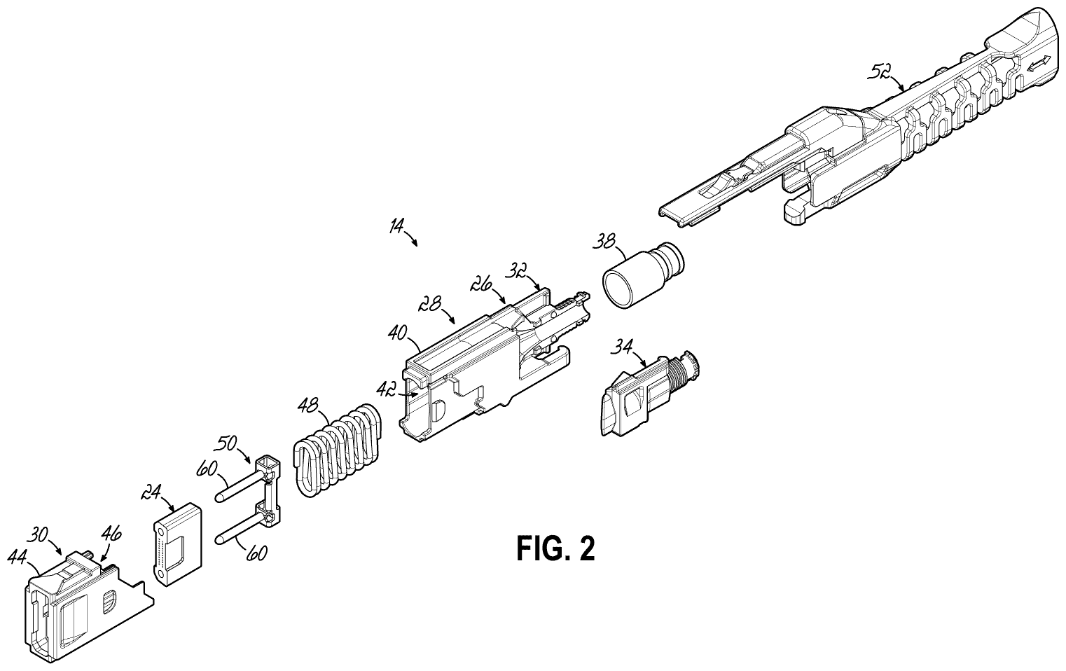

As illustrated in FIGS. 1 and 2, an exemplary fiber optic cable assembly 10 includes a fiber optic cable 12 and at least one fiber optic connector 14 terminating the fiber optic cable 12 at a first end 16 of the fiber optic cable 12 (one shown). A second opposite end (not shown) of the fiber optic cable 12 may also include a fiber optic connector, e.g., similar to fiber optic connector 14, terminating the fiber optic cable 12 at that end. The fiber optic cable 12 carries a plurality of optical fibers 18 (see FIG. 4) within an outer jacket or sheath 20 of the fiber optic cable 12. In one embodiment, for example, the fiber optic cable 12 may carry twelve optical fibers 18. In an alternative embodiment, however, the fiber optic cable 12 may carry a plurality of cable subunits (e.g., six or eight cable subunits; not shown), where each cable subunit may carry a plurality of optical fibers, such as twelve optical fibers 18. It should be appreciated, however, that the fiber optic cable 12 and/or the cable subunits of the fiber optic cable 12 may carry more of less optical fibers depending on the particular application.

Through the process of connectorization, the optical fibers 18 carried by the fiber optic cable 12 may be terminated by one or more fiber optic connectors 14 (one shown). The fiber optic connector 14 of the fiber optic cable assembly 10 generally includes a housing assembly 22 and a ferrule 24 substantially positioned in the housing assembly 22. In the embodiment shown in FIGS. 1 and 2, the fiber optic connector 14 is illustrated as a multifiber connector in the form of an MMC fiber optic connector sold by US Conec Ltd. The MMC fiber optic connector is considered to be a part of a class of fiber optic connectors referred to as very small form factor (VSFF) connectors, which have small footprint ferrules 24 and connector housing assemblies compared to standard fiber optic connectors in the telecommunications industry. By way of example, and as discussed in more detail below, the MMC fiber optic connector utilizes a very small form factor MT-style ferrule, referred to as a TMT ferrule. Aspects of the present disclosure are directed to measuring processes for VSFF ferrules, such as the TMT ferrule of the MMC fiber optic connector, and their associated optical fibers 18. While aspects of the disclosure will be described in reference to the MMC fiber optic connector and the TMT ferrule, it should be understood that aspects of the disclosure may be applicable to other fiber optic connectors (and more specifically the ferrules used therein), including both conventional multifiber fiber optic connectors and VSFF fiber optic connectors other than the MMC fiber optic connector.

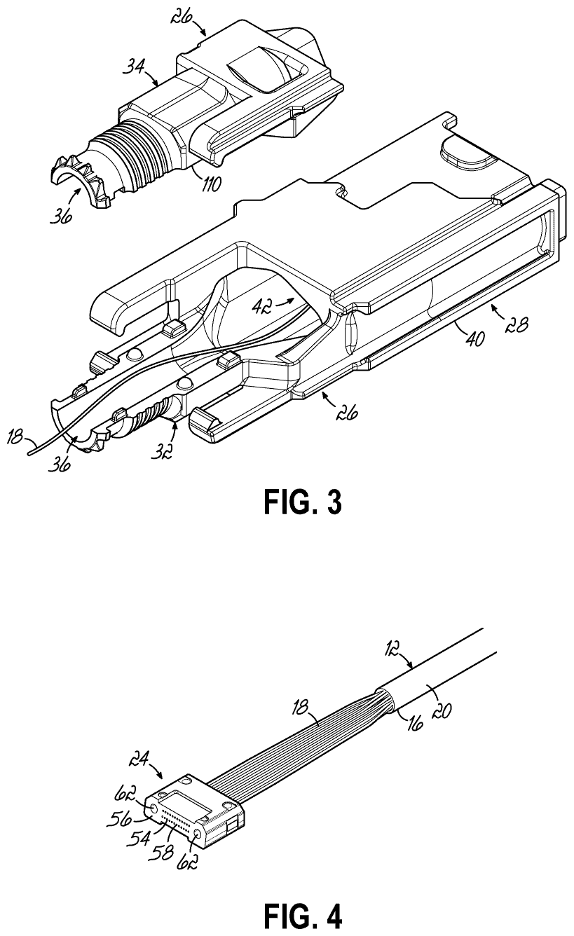

As illustrated in FIGS. 1-3, the MMC housing assembly 22 may include a crimp body 26 (also referred to as a rear housing component or body in this disclosure) and a first housing component or body 30 (also referred to as a shroud for the particular embodiment shown). The crimp body 26 may have a two-part construction including a first crimp body portion 32 and a second crimp body portion 34 that are configured to be assembled together (such as along a midline) to form the crimp body 26. Each of the first and second crimp body portions 32, 34 includes respective passageway portions such that when the first and second crimp body portions 32, 34 are clamped together, a central passageway 36 extends through the crimp body 26 and is configured to receive the plurality of optical fibers 18 carried by the fiber optic cable 12 (or subunit cable). As described below, the crimp body 26 is configured to receive a crimp band 38 along a distal portion thereof to clamp or secure the first crimp body portion 32 and the second crimp body portion 34 in the assembled state. Alternatively, or additionally, the first crimp body portion 32 and the second crimp body portion 34 may be secured together in the assembled state by using adhesive, snap-fit features, or other means.

In the embodiment shown, the first crimp body portion 32 defines a housing portion 28 that interfaces with the first housing component 30. The housing portion 28 includes a generally rectangular housing body 40 and a central housing passageway 42 extending through the housing portion 28. The central housing passageway 42 is in communication with the crimp body passageway 36 and allows the optical fibers 18 to pass therethrough. The housing portion 28 is connected to the crimp body 26, such as being integrally formed with the first crimp body portion 32. In this embodiment, the second crimp body portion 34 may operate as a housing assembly cap for accessing and closing off the distal portion of the housing assembly 22 after the optical fibers 18 have been inserted through the crimp body 26 of the housing assembly 22.

The first housing component 30 includes a generally rectangular component body 44 and a central component passageway 46 extending through the component body 44. The central component passageway 46 is configured to be in communication with the central housing passageway 42 when the housing assembly 22 is assembled. The central component passageway 46 may include a seat (not shown) that receives the ferrule 24 and prevents the ferrule 24 from passing through the first housing component 30. The seat is positioned near a proximal end of the first housing component 30 such that a proximal portion of the ferrule 24 extends from the first housing component 30 when the ferrule 24 is positioned in the seat and the first housing component 30 is releasably connected to the housing portion 28 of the housing assembly 22, such as through a snap-fit type of connection. The fiber optic connector 14 may further include a spring 48 for biasing the ferrule 24 toward its seat in the first housing component 30. Moreover, depending on whether the fiber optic connector 14 is a male-type connector, the fiber optic connector 14 may include a guide pin subassembly 50. The guide pin subassembly 50 may be omitted in a female-type connector. Lastly, the fiber optic connector 14 may include a boot subassembly 52 to protect any exposed optical fibers adjacent the rear of the fiber optic connector 14 from being excessively bent during use.

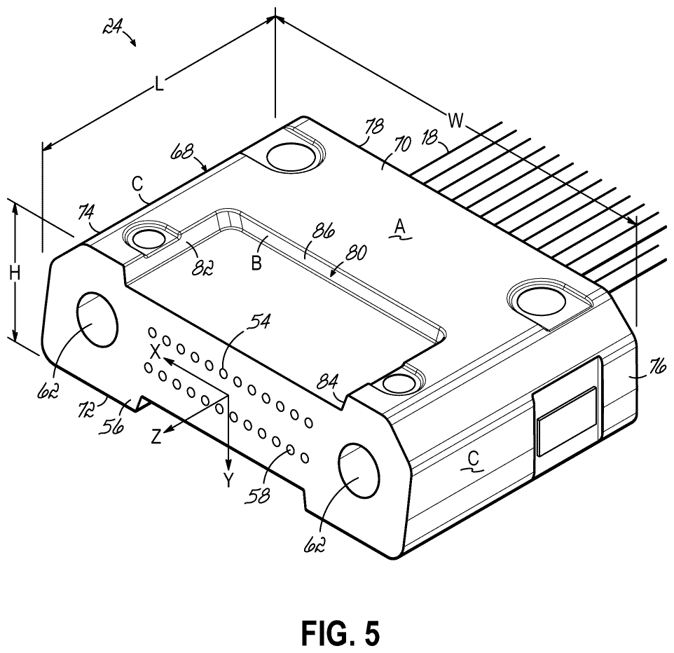

To connectorize the fiber optic cable 12 with the fiber optic connector 14, first a length of the outer sheath 20 of the fiber optic cable 12 may be stripped to provide the plurality of optical fibers 18, such as a plurality of bare optical fibers 18. Next, the boot subassembly 52, crimp band 38, crimp body 26 (without the second crimp body portion 34 and including housing portion 28), spring 48 and optionally the guide pin subassembly 50 may be loaded onto the stripped end of the fiber optic cable 12. The optical fibers 18 may then be inserted into respective fiber bores 54 of the ferrule 24. As is typical, the optical fibers 18 may be inserted into the fiber bores 54 such that a small amount of fiber extends from an end face 56 of the ferrule 24. The optical fibers 18 may then be cleaved so that their respective end faces 58 (FIG. 5) reside even closer to the end face 56 of the ferrule 24. Alternatively, cleaving may take place before inserting the optical fibers 18 into the ferrule 24, and the insertion of the optical fibers 18 into the ferrule 24 controlled so that the cleaved end faces 58 reside close to the end face 56. The optical fibers 18 may then be secured to the ferrule 24, such as by the application of adhesive within the fiber bores 54 of the ferrule 24, before or after inserting the optical fibers 18 into the fiber bores 54. The end face 56 of the ferrule 24 may be at least partially shaped during manufacture of the ferrule 24 and only a small amount of shaping may be necessary to finalize the desired end face geometry (e.g., so as to have an eight-degree angled end face profile). The final stage of shaping the end face 56 of the ferrule 24 may be achieved during the polishing process of the fiber optic connector 14. Additionally, the polishing process may shape the end faces 58 of the optical fibers 18 and remove any defects, debris, etc. that may be on the end faces 56, 58 of the ferrule 24 and/or optical fibers 18, respectively. To confirm the quality of the ferrule end face geometry, the ferrule 24 may be subjected to a measuring process. By way of example, and without limitation, the measuring process may confirm radius of curvature, interface angle, apex location, concentricity, etc. Various instrumentation for measuring ferrule end face geometries is well known in the telecommunications industry. Details of the measuring process, and more particularly how to fixate the ferrule 24 during the measuring process will be described more fully below.

Subsequent to the measuring process, the ferrule 24 and optical fibers 18, along with at least a portion of the spring 48 and optionally the guide pin subassembly 50, may be inserted into the first housing component 30 so that the ferrule 24 is located in its seat near the proximal end of the first housing component 30. The first crimp body portion 32 and housing portion 28 may then be moved proximally along the optical fibers 18 so that the first housing component 30 may be releasably assembled to the housing portion 28 through, for example, a snap-fit connection. When so assembled, a distal end of the spring 48 engages with a stop or shoulder (not shown) in the housing portion 28 and the proximal end of the spring 48 engages a rear of the ferrule 24 to bias the ferrule 24 in the proximal direction toward its seat in the first housing component 30. If the guide pin subassembly 50 is present, the proximal end of the spring 48 is configured to engage a rear of the guide pin subassembly 50 to bias both the ferrule 24 and the guide pin subassembly 50 in the proximal direction.

As illustrated in FIGS. 1 and 2, the guide pins 60 of the guide pin subassembly 50 may extend through bores 62 in the ferrule 24 and beyond the end face 56 of the ferrule 24. The guide pins 60 are configured to be received within corresponding bores in the ferrule of the mating (e.g., female) fiber optic connector (not shown) across the optical connection. The optical fibers 18 extending into the fiber optic connector 14 may be positioned in the passageway portion of the first crimp body portion 32. To complete the assembly of the fiber optic connector 14, the second crimp body portion 34 may be positioned over the first crimp body portion 32 and the crimp band 38 applied to a distal portion thereof so as to clamp or secure the first and second crimp body portions 32, 34 together. Alternatively, or additionally, the first crimp body portion 32 and the second crimp body portion 34 may be secured together in the assembled state by using adhesive, snap-fit features, or other means. The boot subassembly 52 may then be moved proximally along the fiber optic cable 12 to engage with the crimp body 26.

FIGS. 4 and 5 illustrate the fiber optic cable 12 having the optical fibers 18 carried thereby secured to the ferrule 24 of the fiber optic connector 14. For simplicity, the other components of the fiber optic connector 14 have been omitted from their position about the optical fibers 18. As discussed above, the ferrule 24 of the fiber optic connector 14 is illustrated as a multi-fiber ferrule of an MMC fiber optic connector. Such a ferrule is known as a TMT ferrule or miniature MT ferrule, and examples are described in PCT Patent Application Pub. No. WO 2021/217050 A1, the disclosure of which is herein incorporated by reference. It should be appreciated, however, that aspects of the present disclosure are not limited to the TMT ferrule and may be found advantageous to other ferrule and fiber optical connector configurations. In this embodiment, the ferrule 24 includes a generally rectangular ferrule body 68 defining a top surface 70, a bottom surface 72, opposed side surfaces 74, 76, a front end face 56, and a rear end face 78. The plurality of fiber bores 54 extends between the rear end face 78 and the front end face 56 and are configured to receive a respective one of the plurality of optical fibers 18 of the fiber optical cable 12, as mentioned above. As illustrated, the ferrule 24 may include twenty-four ferrule bores 54 to receive twenty-four optical fibers 18. It should be appreciated, however, that the ferrule 24 may include more or less fiber bores 54 for receiving more or less optical fibers 18 depending on the particular application. The ferrule 24 may also include two guide pin bores 62 extending between the rear end face 78 and the front end face 56 and configured to receive respective guide pins 60 of the guide pin subassembly 50 in the event the fiber optic connector 14 is configured as a male-type connector. In an exemplary embodiment, the guide pin bores 62 may be adjacent the opposed side surfaces 74, 76 of the ferrule body 68.

As best shown in FIG. 5, the ferrule 24 includes a depression or cavity 80 in the top surface 70 of the ferrule body 68. The cavity 80 is open to the front end face 56 of the ferrule body 68 and generally includes a pair of opposed side walls 82, 84 and a rear wall 86. In an exemplary embodiment, the side walls 82, 84 may be arranged generally parallel to the side surfaces 74, 76 of the ferrule body 68 and the rear wall 86 may be arranged generally parallel to the rear end face 78 (and front end face 56) of the ferrule body 68. The cavity 80 may extend from the front end face 56 toward the rear end face 78 in a length direction for part of the length L of the ferrule body 68. Moreover, the cavity 80 may be centered about a vertical midplane of the ferrule body 68 and extend in a width direction for part of the width W of the ferrule body 68. Furthermore, the cavity 80 may extend from the top surface 70 toward the bottom surface 72 in a height direction for part of the height H of the ferrule body 68. It should be appreciated that the cavity 80 may have different length, width, and height dimensions depending on the embodiment.

In general, in order to clamp a workpiece within a processing fixture in a predetermined location, the workpiece will generally include at least one and preferably a plurality of reference datums. The reference datums on the workpiece are configured to cooperate with respective reference datums on the processing fixture to position the workpiece in the predetermined location. In this way, processing steps may be performed knowing that the workpiece is in its predetermined location. In this regard, the processing fixture typically includes one or more clamp mechanisms that position the workpiece in its predetermined location and secure the workpiece relative to the processing fixture in the predetermined location. The one or more clamp mechanisms apply one or more clamping forces to secure the position of the workpiece within the processing fixture. As can be appreciated, this prevents the workpiece from moving during execution of the processing steps on the workpiece.

In many cases, processing fixtures are configured to adjust the position of the workpiece relative to the fixture in three dimensions. This allows the workpiece to be precisely positioned at the predetermined location. For example, using a Cartesian coordinate system for description purposes, processing fixtures may be configured to adjust the workpiece in the X, Y, and Z directions and apply a clamping force in the X, Y, and Z directions to secure the workpiece to the processing fixture.

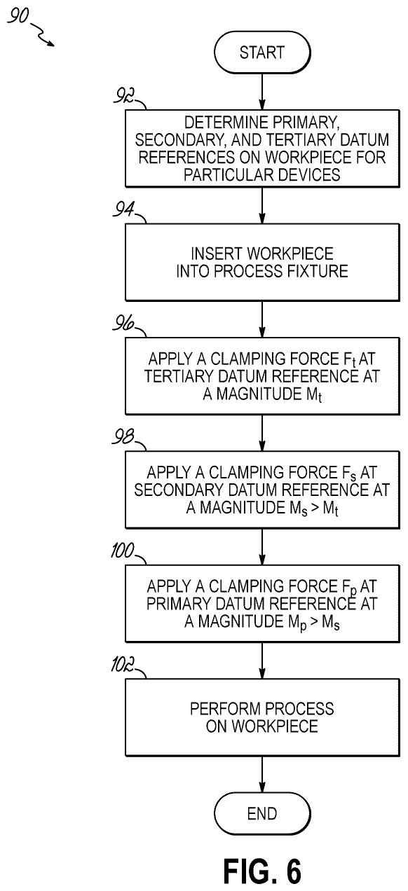

In this regard, and in reference to FIG. 5, with the ferrule 24 operating as the workpiece and a measuring fixture operating as the processing fixture, the ferrule 24 may include at least two, and possibly three datum surfaces A, B, and C used to precisely position the ferrule 24 within the measuring fixture at the predetermined location. In reference to the Cartesian coordinate system illustrated in FIG. 5, the A datum surface is configured to precisely position the ferrule 24 in the Y direction; the B datum surface is configured to precisely position the ferrule 24 in the Z direction; and the C datum surface is configured to precisely position the ferrule 24 in the X direction. And more specifically for the embodiment shown, the top surface 70 of the ferrule body 68 serves as the A datum surface, the rear wall 86 of the cavity 80 serves as the B datum surface, and at least one of the opposed side surfaces 74, 76 serves as the C datum surface. The A, B, and C datum surfaces on the ferrule 24 are configured to cooperate with corresponding D, E, and G datum surfaces (see e.g. FIG. 6) on the measuring fixture to secure the ferrule 24 in the predetermined location using the one or more clamp mechanisms. More particularly, the A datum surface of the ferrule 24 is configured to engage with the D datum surface of the measuring fixture under a clamping force F_{y} of the at least one clamp mechanism; the B datum surface of the ferrule 24 is configured to engage with the E datum surface of the measuring fixture under a clamping force F_{z} of the at least one clamp mechanism; and the C datum surface of the ferrule 24 is configured to engage with the G datum surface of the measuring fixture under a clamping force Fₓ of the at least one clamp mechanism. The clamping forces Fₓ, F_{y}, and F_{z} must have sufficient magnitudes Mₓ, M_{y}, and M_{z} to prevent the ferrule 24 from moving while in the fixture.

The inventors have discovered that as the size of multifiber ferrules have decreased, such as reaching sizes suitable for very small form factor connectors, the manner in which the ferrule 24 is clamped within the measuring fixture may have a significant impact on the quality of the processing steps performed on the ferrule 24 while in the fixture. With more particularity, the inventors have discovered that the order of application of the clamping forces Fₓ, F_{y}, and F_{z} and the relative magnitudes of the clamping forces Mₓ, M_{y}, and M_{z}, respectively, may have a significant impact on the quality of the measurements performed on the end face 56 of the ferrule 24.

In this regard, and in accordance with an aspect of the disclosure, the inventors have discovered that mispositioning ferrules in current measuring fixtures may be reduced through a specific application or sequencing of the clamping forces Fₓ, F_{y}, and F_{z} on the ferrule 24 within the port of the measuring fixture. More particularly, consistent placement of the ferrule 24 in the predetermined position in the measuring fixture may be achieved by applying the clamping forces Fₓ, F_{y}, and F_{z} in a preferred order and at preferred relative magnitudes Mₓ, M_{y}, and M_{z}, respectively. In this regard, and in general, depending on the particular process being performed on the workpiece, deviations in position of the workpiece in the port of the processing fixture may have different consequences in the quality/performance of the workpiece subjected to the process during operations utilizing of the workpiece. Generally speaking, and by way of example, a workpiece may have at least two and possibly three reference datums A, B, C for positioning the workpiece within the processing fixture in a predetermined location. Deviations in the position of the three reference datums A, B, C within the processing fixture do not generally have the same impact on quality/performance of the workpiece during operation. For example, a deviation in the C reference datum may have a very low or negligible impact on the quality/performance of the workpiece during operation; deviation of the B reference datum may have a moderate impact on the quality/performance of the workpiece during operation; and a deviation of the A reference datum may have a high impact on the quality/performance the workpiece during operation. In this case, the A reference datum may be referred to as the “primary reference datum”; the B reference datum may be referred to as the “secondary reference datum”; and the C reference datum may be referred to as the “tertiary reference datum.” In other words, deviations in the position of the reference datums are ranked from most important to least important on the quality/performance of the workpiece during operation. One of ordinary skill in the art will understand how to determine the importance of the reference datums on the quality/performance of the workpiece during operation. By way of example, this may be done by controlled experimentation on a workpiece.

Generally, it has been discovered that the workpiece may be more consistently located at its predetermined location within the processing fixture if the clamping forces on the workpiece are applied in ascending order (i.e., least important to most important). For example, in one embodiment, the secondary clamping force (i.e., the clamping force to seat the secondary reference datum) may be applied prior to applying the primary clamping force (i.e., the clamping force to seat the primary reference datum). Moreover, it has been discovered that consistent positioning of the ferrule in its predetermined location may be further achieved by ensuring that the magnitudes of the clamping force are also in ascending order (lowest magnitude to greatest magnitude). For example, in one embodiment, the magnitude of the clamping force to seat the secondary reference datum may be less than the magnitude of the clamping force to seat the primary reference datum. Furthermore, in another embodiment with at least three reference datums, while there may be some variability in when the tertiary clamping force (i.e., the clamping force to seat the tertiary reference datum) may be applied, in a preferred embodiment, the tertiary clamping force may be applied to the workpiece prior to the secondary clamping force being applied to the workpiece. Moreover, the magnitude of the tertiary clamping force may be less than the magnitude of the secondary clamping force.

A generalized method 90 for processing a workpiece in a processing fixture is illustrated in FIG. 6. The workpiece may have at least two, and possibly three reference datums (three reference datums will be described below). The method 90 starts with an initial step 92 of determining which of the reference datums of the workpiece constitute the tertiary reference datum, the secondary reference datum, and the primary reference datum. As noted above, one of ordinary skill in the art will understand how to do this step. This determination may depend on the particular process being performed on the workpiece and may include determining the impact that deviations in the position of the workpiece in the processing fixture have on the quality/performance of the workpiece during operation. The workpiece may then be inserted into the processing fixture according to step 94. In a next step 96, a clamping force F₁ may be applied to seat the tertiary reference datum relative to the processing fixture at a first magnitude Mₜ. In a next step 98, a clamping force Fₛ may be applied to seat the secondary reference datum relative to the processing fixture at a second magnitude Mₛ. The second magnitude Mₛ of the clamping force Fₛ is greater than the first magnitude Mₜ of the clamping force Ft. In a further step 100, a clamping force Fₚ may be applied to seat the primary reference datum relative to the processing fixture at a third magnitude Mₚ. The third magnitude Mₚ of the clamping force Fₚ is greater than the second magnitude Mₛ of the clamping for Fₛ. In another step 102, the workpiece may be subjected to various processing steps while clamped within the processing fixture.

Turning now to the application of processing a ferrule 24 in a measuring fixture 106, it has been discovered that deviations in the predetermined position of the ferrule 24 in the port 108 of the measuring fixture 106 in the X direction have very little effect on the quality/performance of end faces 56 of the ferrule 24. In other words, additional optical losses across an optical connection due to deviations in X direction positioning of the ferrule 24 in the port 108 of the measuring fixture 106 is expected to be very low. Consequently, the X direction reference datum, which corresponds to the C datum surface of the ferrule 24, may be identified as the tertiary reference datum. It has also been discovered that deviations in the predetermined position of the ferrule 24 in the measuring fixture 106 in the Z direction have a moderate effect on the quality/performance of end faces 56 of the ferrule 24 during operation. In other words, additional optical losses across an optical connection due to deviations in Z direction positioning of the ferrule 24 in the port 108 of the measuring fixture 106 is expected to be moderate. Consequently, the Z direction reference datum, which corresponds to the B datum surface of the ferrule 24, may be identified as the secondary datum reference. Lastly, it has been discovered that deviations in the predetermined position of the ferrule 24 in the measuring fixture 106 in the Y direction have a significant effect on the quality/performance of end faces 56 of the ferrule 24. In other words, additional optical losses across an optical connection due to deviations in Y direction positioning of the ferrule 24 in the port 108 of the measuring fixture 106 is expected to be the most significant. Consequently, the Y direction reference datum, which corresponds to the A datum surface of the ferrule 24, may be identified as the primary reference datum.

With step 92 of method 90 now completed for the application of a ferrule 24 being subjected to a measuring process, the ferrule 24 may be inserted into the port 108 of the measuring fixture 106 according to step 94. In this regard, the ferrule 24 may be loaded into the port 108 of the measuring fixture 106 from the rear so as to accommodate the optical fibers 18 that are connected to and extending away from the ferrule 24. Steps for securing the ferrule 24 within the measuring fixture 106 according to method 90 may now be implemented in the proper sequence. In this regard, and as to step 96 of method 90, a first clamp mechanism may be activated so that the C datum surface of the ferrule 24 (i.e., the tertiary reference datum) engages with the G datum surface of the port 108 of the measuring fixture 106. For example, the first clamp mechanism may be a linear actuator that applies a clamping force Fₓ on the ferrule 24 so that the C datum surface and the G datum surface are engaged. Moving to the next step 98 of the method 90, in one embodiment, a second clamp mechanism may be activated so that the B datum surface of the ferrule 24 (i.e., the secondary reference datum) engages with the E datum surface of the port 108 of the measuring fixture 106. For example, the second clamp mechanism may be a linear actuator that applies a clamping force F_{z} on the ferrule 24 so that the B datum surface and the E datum surface are engaged. Similarly, moving to the next step 100 of the method 90, in one embodiment, a third clamp mechanism may be activated so that the A datum surface of the ferrule 24 (i.e., the primary reference datum) engages with the D datum surface of the port 108 of the measuring fixture 106. For example, the third clamp mechanism may be a linear actuator that applies a clamping force F_{y} on the ferrule 24 so that the B datum surface and the D datum surface are engaged.

In accordance with the method 90, the clamping force Fₓ imposed on the ferrule 24 from the first clamp mechanism has the lowest magnitude Mₓ of the clamping forces Fₓ, F_{y}, F_{z}, imposed on the ferrule 24. In one embodiment, the magnitude M_{z} of the clamping force F_{z} imposed on the ferrule 24 from the second clamp mechanism may be greater than the magnitude Mₓ of the clamping force Fₓ imposed by the first clamp mechanism. Additionally, the magnitude M_{y} of the clamping force F_{y} imposed on the ferrule 24 from the third clamp mechanism may be greater than the magnitude M_{z} of the clamping force F_{z} imposed by the second clamp mechanism. By way of example, and without limitation, the magnitude M_{y} of the clamping force F_{y} may be at least 5 times greater than the magnitude M_{z} of the clamping force F_{z} imposed by the second clamp mechanism. In one embodiment, the magnitude M_{y} of the clamping force F_{y} may be between about 5 and about 20 times greater than the magnitude M_{z} of the clamping force F_{z} imposed by the second clamp mechanism.

After applying the steps 92-100 of method 90 to secure the ferrule 24 to the port 108 of the measuring fixture 106, the measuring process on the end face 56 of the ferrule 24 may commence. Those of ordinary skill in the art understand the various measuring processes traditionally performed on ferrules 24 and, for sake of brevity, a further discussion of such processes will not be described herein. Once the measuring process has been completed, the first, second, and third clamp mechanisms may be released and the ferrule 24 may be removed from the port 108 of the measuring fixture 106. From here, other processes, such as insertion loss measurements and/or assembly processes (e.g., of the housing assembly 22, spring 48, guide pin subassembly 50 (if present), crimp body 26, crimp band 38 and boot subassembly 52), may be performed to complete the assembly of the fiber optic connector 14.

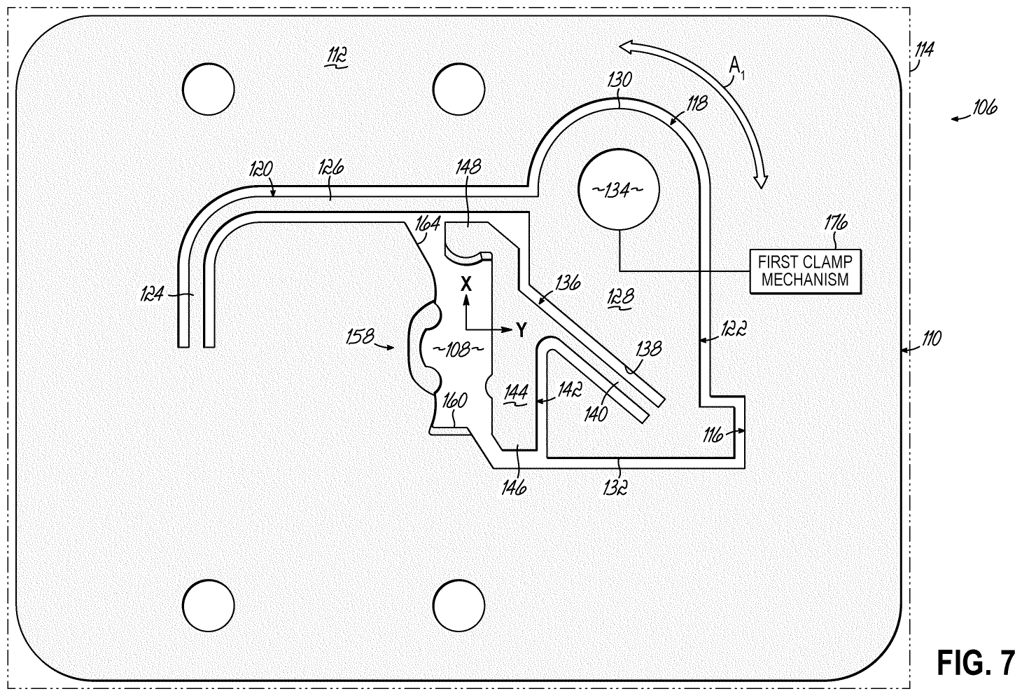

In one embodiment (not shown), the measuring fixture 106 may include three different (e.g., separate) clamp mechanisms for imposing clamping forces Fₓ, F_{y}, and F_{z} at magnitudes Mₓ, M_{y}, and M_{z}, respectively, on the ferrule 24. In one embodiment, the clamp mechanisms may each be independently controlled and operated from the other clamp mechanisms. However, FIG. 7 illustrates a measuring fixture 106 having an alternative clamping arrangement in accordance with an embodiment of the disclosure. Because the measuring processes on the end face 56 of the ferrule 24 tend to be no contact or minimal contact (e.g., laser-based interferometry), the magnitude requirements Mₓ, M_{y}, and M_{z} of the clamping forces Fₓ, F_{y}, and F_{z} in order to precisely secure the ferrule 24 in the predetermined location may be relatively small compared to, for example, the clamping forces used during polishing processes (or other contact processes). Accordingly, in one embodiment, the at least one, and preferably each, of the clamp mechanisms of the measuring fixture 106 may be provided at least in part by spring-based flexure elements. The use of flexure elements, as opposed to solely fixed actuators or the like, simplifies the design of the measuring fixture 106.

As illustrated in FIG. 7, the measuring fixture 106 (shown schematically) includes a processing interface 110 defining the port 108 that is configured to receive the ferrule 24 therein. As discussed above, in one embodiment, the ferrule 24 and the optical fibers 18 extending from the rear of the ferrule 24 may be loaded into the measuring fixture 106 from the rear side of the port 108 such that a small length of the ferrule 24 extends from the port 108 at the processing interface 110. In one embodiment, the processing interface 110 includes a generally rectangular interface body 112 configured to be attached to a larger base fixture 114 (shown in phantom in FIG. 6). The interface body 112, in turn, defines a central cutout or aperture 116 that is at least partially and preferably completely surrounded by the interface body 112. A primary flexure element 118 is moveably disposed in the central aperture 116 and cooperates with the interface body 112 to at least partially secure the ferrule 24 within the measuring fixture 106. More particularly, as discussed in more detail below, the port 108 of the measuring fixture 106 is defined in part by the interface body 112 and in part by the primary flexure element 118 in order to provide one or more of the clamp mechanisms that secure the ferrule 24 in the port 108.

In an exemplary embodiment, the primary flexure element 118 disposed in the central aperture 116 may include an elongate primary spring arm 120 and a primary flexure head 122 configured to engage with the ferrule 24 positioned in the port 108 of the measuring fixture 106. In one embodiment, the elongate spring arm 120 may be generally L-shaped and include a first leg 124 and a second leg 126. The first leg 124 includes a first end that is connected to an edge of the central aperture 116 and an opposite second end. The second leg 126 includes a third end that is connected to the second end of the first leg 124 and a fourth end that is connected to the primary flexure head 122. The first and second legs 124, 126 are relatively thin in cross dimension (as compared to their length dimension) so as to give the primary flexure head 122 the ability to flex or resiliently deform within the central aperture 116, and within the plane of the processing interface 110 (e.g., similar to a spring) under the control of a first clamp mechanism.

In an exemplary embodiment, the primary flexure head 122 includes a head body 128 having a first end 130 and an opposite second end 132. The fourth end of the second leg 126 of the spring arm 120 may be attached to the primary flexure head 122 adjacent its first end 130. Additionally, the first end 130 of the primary flexure head 122 may include a clamp aperture 134 that is configured to interface with the first clamp mechanism, such as an actuator (not shown) of the measuring fixture 106, for moving the primary flexure element 118, and more particularly the primary flexure head 122, along an arcuate path, (as depicted by arrow A₁), between an opened position and a closed position relative to the interface body 112. The opened and closed positions, and how those positions relate to the clamping of the ferrule 24 in the port 108, will be described in more detail below. In one embodiment, the first end 130 of the primary flexure head 122 may be arcuately shaped (e.g., semi-circular). This shape is merely exemplary and the first end 130 of the flexure head 122 may have a different shape and remain within the scope of the disclosure.

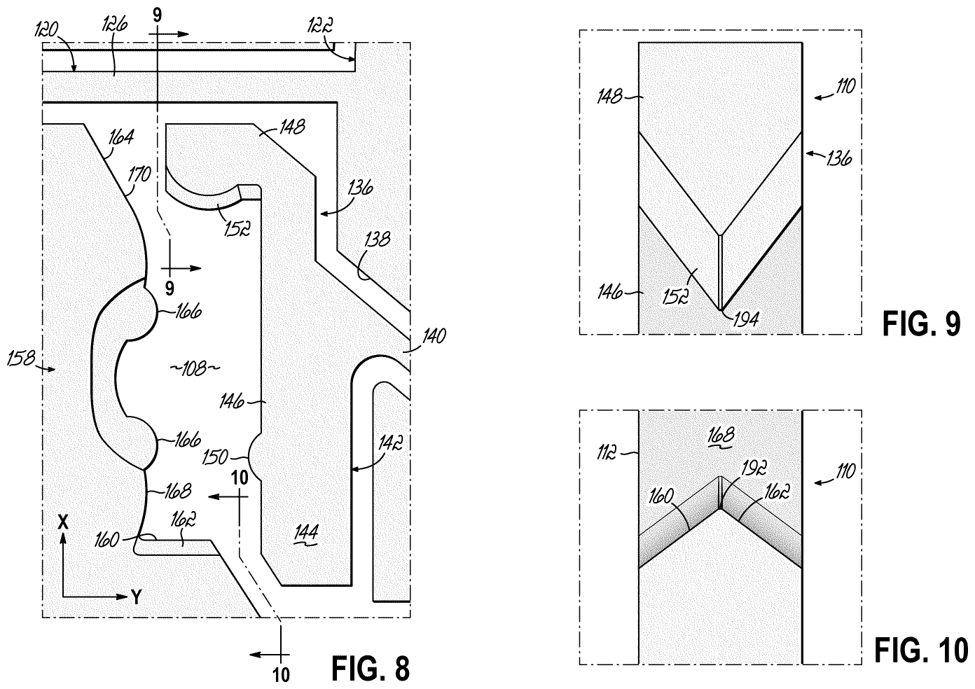

In the embodiment shown in FIG. 7, and as further illustrated in FIG. 8, the primary flexure head 122 carries a secondary flexure element 136 extending away from the primary flexure head 122 adjacent its second end 132 and is configured to engage with the ferrule 24 positioned in the port 108 of the measuring fixture 106. For example, in one embodiment, the primary flexure head 122 may include a slot 138 open to an edge of the primary flexure head 122 that extends into the flexure head body 128 and terminates adjacent the second end 132 of the primary flexure head 122. The secondary flexure element 136 is disposed, at least in part, in the slot 138 in the primary flexure head 122. In one embodiment, the secondary flexure element 136 includes an elongate spring arm 140 and a secondary flexure head 142. The elongate spring arm 140 includes a first end that is connected to an edge of the slot 138 at its terminated end adjacent the second end 132 of the primary flexure head 122 and an opposite second end. The spring arm 140 is relatively thin in cross dimension (as compared to its length dimension) so as to give the secondary flexure head 142 the ability to flex or resiliently deform relative to the primary flexure head 122, and within the plane of the processing interface 110 (e.g., similar to a spring).

In an exemplary embodiment, and as illustrated in FIG. 8, the secondary flexure head 142 includes a generally L-shaped head body 144 connected to the second end of the spring arm 140 and having a first leg 146 and a second leg 148. The first leg 146 includes a first end and an opposite second end. The second leg 148 includes a third end that is connected to the second end of the first leg 146 and an opposite fourth end. The second end of the spring arm 140 is connected to the first leg 146 of the head body 144 along an outer edge and adjacent to the second end of the first leg 146 of the head body 144. As noted above, the second flexure head 142 is configured to engage with the ferrule 24. In this regard, the first leg 146 of the secondary flexure head 142 includes at least one first projection 150 (one shown) extending from an inner edge of the first leg 146 and configured to engage with the ferrule 24, and the second leg 148 of the secondary flexure head 142 includes at least one second projection 152 (one shown) extending from an inner edge of the second leg 148 at the fourth end and also configured to engage with the ferrule 24. The manner in which the first and second projections 150, 152 are configured to engage with the ferrule 24 to secure the ferrule 24 within the port 108 of the measuring fixture 106 will be described in more detail below.

As noted above, the port 108 of the measuring fixture 106 is defined at least in part by the interface body 112 and at least in part by the primary flexure element 118. More particularly, as illustrated in FIG. 8, the secondary flexure element 136 is the portion of the primary flexure element 118 that is configured to engage with the ferrule 24 positioned within the port 108 of the measuring fixture 106. In this regard, the interface body 112 includes an engagement region 158 that is adjacent to the secondary flexure element 136 and is configured to engage with the ferrule 24 when positioned in the port 108 of the measuring fixture 106. In one embodiment, the engagement region 158 includes a first edge 160 that defines at least part of the port 108 and is configured to engage the ferrule 24 when the ferrule 24 is received in the port 108 of the measuring fixture 106. In an exemplary embodiment, the first edge 160 defines a first shoulder 162 extending toward the secondary flexure head 142 of the secondary flexure element 136. The engagement region 158 further includes a second edge 164 that defines at least a part of the port 108 and is similarly configured to engage the ferrule 24 when the ferrule 24 is received in the port 108 of the measuring fixture 106. The second edge 164 includes at least one projection 166 extending toward the secondary flexure head 142 of the secondary flexure element 136. In the embodiment shown in FIGS. 7 and 8, the second edge 164 includes two projections 166. However, in an alternative embodiment, as shown in FIG. 14, the second edge 164 may include only one projection 166 configured to engage with the ferrule 24. In a further embodiment (not shown), the second edge 164 may include more than two projections 166. In addition, the second edge 164 of the engagement region 158 may include a second shoulder 168 and a third shoulder 170 on opposed sides of the at least one projection 166. Similar to the at least one projection 166, the second and third shoulders 168, 170 are configured to engage the ferrule 24 when the ferrule 24 is received in the port 108 of the measuring fixture 106.

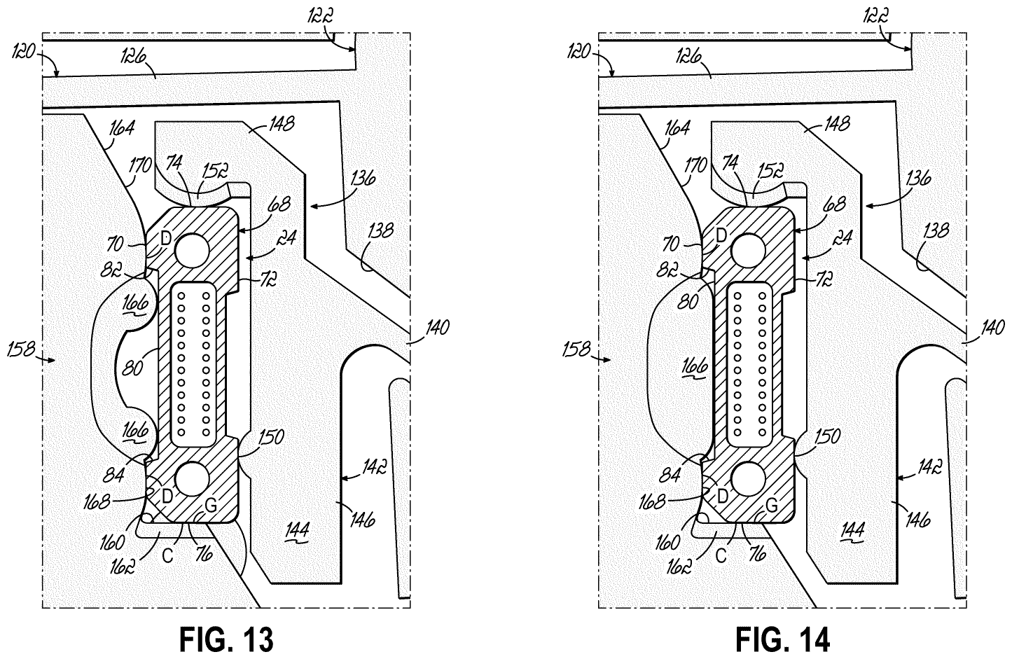

In the embodiment shown in FIGS. 7-15, the measuring fixture 106 may include at least two clamp mechanisms for securing the ferrule 24 within the port 108 of the measuring fixture 106. As noted above, a first clamp mechanism 176 may be configured to move the primary flexure element 118 in an arcuate path, as indicated by arrow A₁, between an opened position and a closed position. In the opened position, the port 108 is larger than the ferrule 24 and the ferrule 24 may be easily inserted into the port 108 of the measuring fixture 106 from the rear. In the closed position, the secondary flexure element 136 carried by the primary flexure element 118 engages the ferrule 24 to at least partially clamp the ferrule 24 within the port 108 in its predetermined position.

In one embodiment, the first clamp mechanism 176 may be configured to clamp two reference datums on the ferrule 24 with corresponding reference datums associated with the port 108 of the measuring fixture 106 (as opposed to each reference datum having a different clamp mechanism). By way of example, and without limitation, in one embodiment, the first clamp mechanism 176 may be configured to engage the C reference datum on the ferrule 24 with the G reference datum associated with the port 108 of the measuring fixture 106 and engage the A reference datum on the ferrule 24 with the D reference datum associated with the port 108 of the measuring fixture 106. In other words, the first clamp mechanism 176 may be configured to impose the clamping force Fₓ to cause engagement or further engagement between the C datum surface (i.e., the tertiary reference datum) of the ferrule 24 and the corresponding G reference datum associated with the port 108 of the measuring fixture 106. The first clamp mechanism 176 may also be configured to impose the clamping force F_{y} to cause engagement or further engagement between the A datum surface (i.e., the primary reference datum) of the ferrule 24 and the D reference datum associated with the port 108 of the measuring fixture 106.

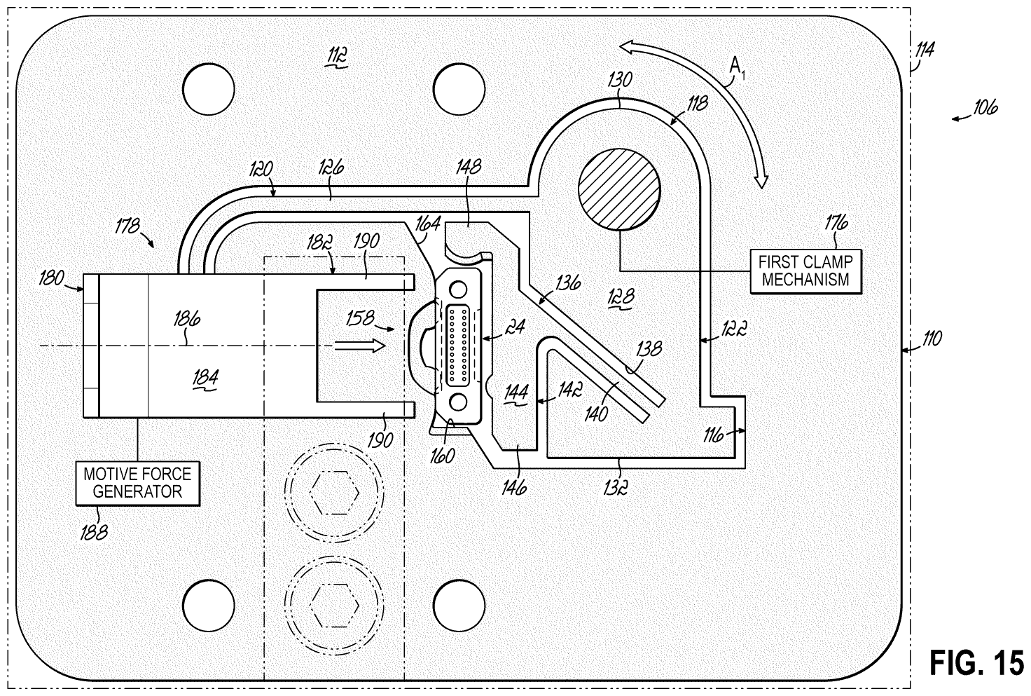

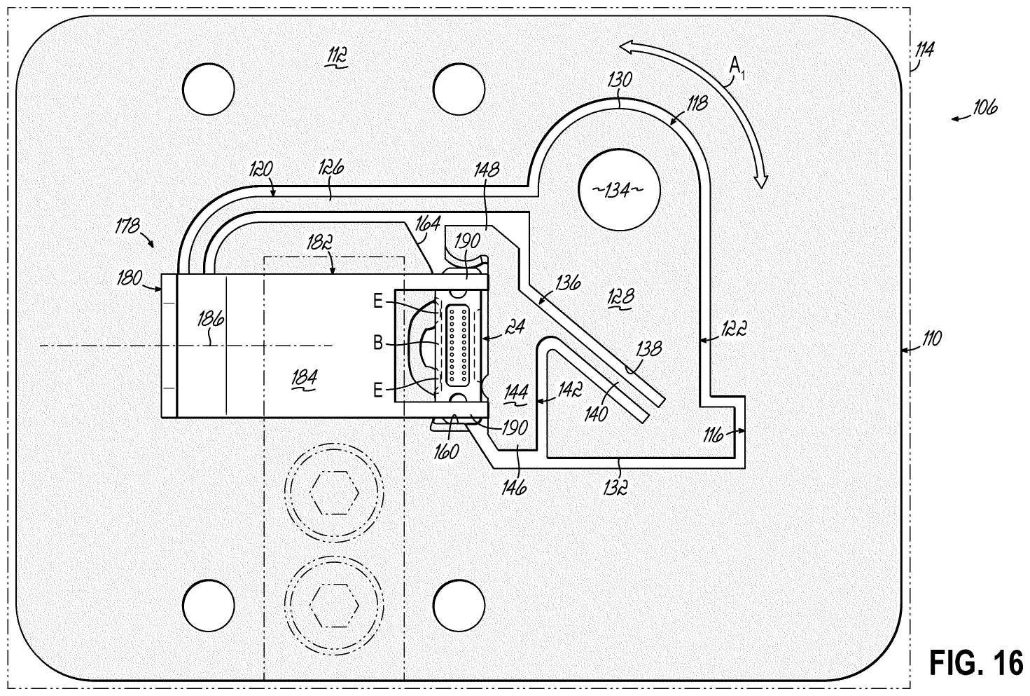

In the exemplary embodiment, and as illustrated in FIGS. 15 and 16, the measuring fixture 106 may further include a second clamp mechanism 178 for partly securing the ferrule 24 within the port 108 of the measuring fixture 106. The second clamp mechanism 178 may include a linear actuator 180 having a headpiece 182 at the distal end of an actuator arm 184. In one embodiment, the actuator arm 184 is moveable along an actuator arm axis 186 under operation of a motive force generator 188. The motive force generator 188 is configured to cause the selective movement of the actuator arm 184 between an extended position and a retracted position. In one embodiment, the motive force generator 188 may be an electric motor, pneumatic motor, or hydraulic motor; however, the motive force generator 188 may take other forms that cause the actuator arm 184 to selectively extend or contract.

In one embodiment, the headpiece 182 of the second clamp mechanism 178 is spring based to apply a spring force on the ferrule 24 when in the port 108 of the measuring fixture 106. For example, the headpiece 182 may include at least one cantilevered spring arm 190 for engaging with the ferrule 24 when the ferrule 24 is in the port 108 and the actuator arm 184 is in the extended position. In an exemplary embodiment, the headpiece 182 may have a forked configuration with a plurality spring arms 190 (e.g., two spring arms) for engaging with the ferrule 24. In one embodiment, the tip ends of the at least one spring arm 190 may be slightly curved in a direction away from the ferrule 24 to allow the spring arms to gradually engage with the ferrule 24 as the actuator arm 184 is moved toward the extended position. In one embodiment, the at least one spring arm 190 of the second clamp mechanism 178 is configured to engage with the rear end face 78 of the ferrule body 68 as explained in more detail below.

In one embodiment, the second clamp mechanism 178 is arranged relative to the processing interface 110, and more particularly, the port 108 therein, such that the actuator axis 186 of the actuator arm 184 is substantially parallel to the Y axis of the Cartesian coordinate system. Thus, movement of the headpiece 182, and more particularly the at least one spring arm 190 thereof is moved in the Y direction into engagement with the ferrule 24 (when positioned in the port 108) and disengagement with the ferrule 24. Moreover, the at least one spring arm 190 is arranged such that when the at least one spring arm 190 engages the ferrule 24 when in the port 108, the at least one spring arm 190 imposes a force on the ferrule 24 in the Z direction. While the second clamp mechanism 178 was described as moving the actuator arm 184 generally in the Y direction to engage/disengage the at least one spring arm 190 with/from the ferrule 24, aspects of the disclosure are not so limited. For example, in an alternative embodiment, the second clamp mechanism 178 may be arranged to move the actuator arm 184 along an actuator axis 186 generally parallel to the X direction to cause a spring force on the ferrule 24 in the Z direction. In a further alternative embodiment, the second clamp mechanism 178 may be arranged to move the actuator arm 184 along an actuator axis 186 generally parallel to the Z direction to cause a spring force on the ferrule 24 in the Z direction. Combinations of these directions may also be possible so long as the clamp mechanism causes a spring force on the ferrule 24 in the Z direction.

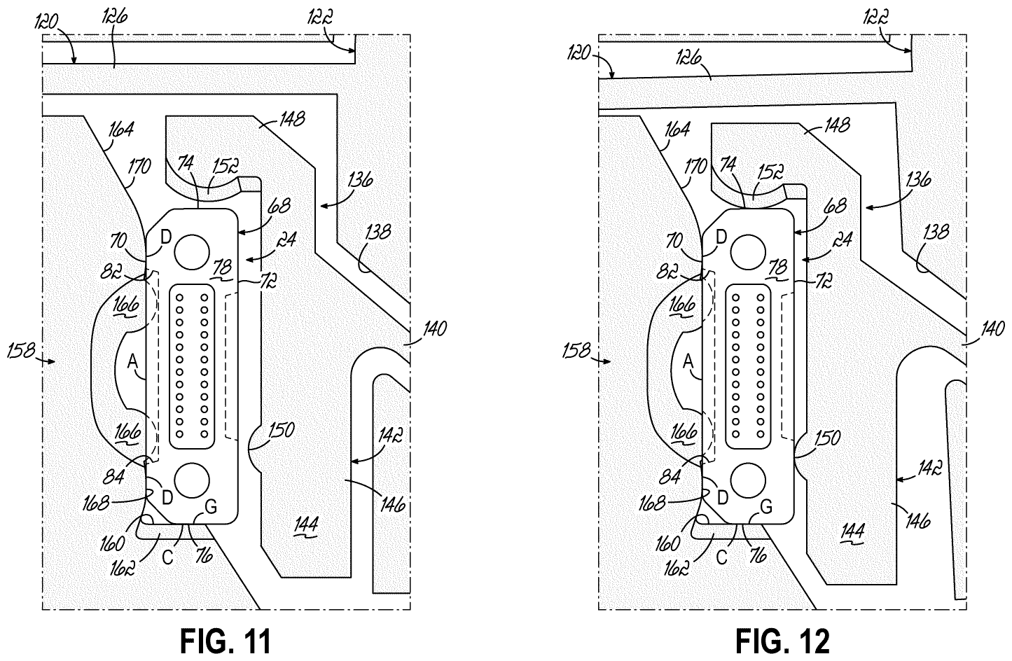

To fixate the ferrule 24 (and its associated optical fibers 18) in the measuring fixture 106, with the first clamp mechanism 176 in the opened position and the second clamp mechanism 178 in the retracted position, the ferrule 24 may be loosely inserted into the port 108 from the rear such that the side surface 76 of the ferrule body 68 sits on the first shoulder 162 of the engagement region 158 of the interface body 112 of the processing interface 110. This is illustrated, for example, in FIGS. 11 and 15. In one embodiment, as shown in FIG. 10, the first shoulder 162 may have a tapered or chamfered configuration that defines a ridge 192 configured to engage with the side surface 76 of the ferrule body 68. In one embodiment, the ridge 192 may define a generally sharp edge configured to engage with the ferrule body 68 along a substantially linear contact region. In an alternative embodiment, the ridge 192 may define a land or flat configured to engage with the ferrule body 68 along a substantially planar contact region. Additionally, with the first clamp mechanism 176 in the opened position, the ferrule 24 may be loosely moved in the Z direction such that the at last one projection 166 on the second edge 164 of the engagement region 158 is located within the cavity 80 of the ferrule body 68 and adjacent to or in engagement with the rear wall 86 of the cavity 80. This is also illustrated in FIGS. 11 and 15.

With the ferrule 24 loosely positioned in the port 108 of the measuring fixture 106 as described above, the first clamp mechanism 176 and the second clamp mechanism 178 may be activated to secure the ferrule 24 within the port 108 of the measuring fixture 106 in its preferred location. In this regard, the first clamp mechanism 176 is moved from its opened position to its closed position and the second clamp mechanism 178 is moved from its retracted position to its extended position. In one embodiment, the first clamp mechanism 176 and the second clamp mechanism 178 are moved in coordination with each other in order to engage the reference surfaces A, B and C on the ferrule 24 and reference surfaces D, E and G associated with the port 108 of the measuring fixture 106 in the desired sequence as discussed above.

In this regard, the first clamp mechanism 176 and the second clamp mechanism 178 are coordinated such that the second projection 152 on the second leg 148 of the head body 144 of the second flexure element 136 makes the first contact with the ferrule 24. More particularly, the second projection 152 of the second flexure element 136 is configured to engage the side surface 74 of the ferrule body 68 and impose a clamping force Fₓ on the ferrule body 68 to cause engagement or further engagement between the side surface 76 of the ferrule body 68 and the first shoulder 162 of the engagement region 158 of the interface body 112. In one embodiment, the second projection 152 may have a tapered or chamfered configuration that defines a ridge 194 configured to engage with the side surface 74 of the ferrule body 68. In one embodiment, the ridge 194 may define a generally sharp edge configured to engage with the ferrule body 68 along a substantially linear contact region. In an alternative embodiment, the ridge 194 may define a land or flat configured to engage with the ferrule body 68 along a substantially planar contact region. Thus, the side surface 76 of the ferrule body 68 operates as the C datum surface and the first shoulder 162 operates as the G datum surface. In other words, the first clamp mechanism 176 and the second clamp mechanism 178 are coordinated to engage the tertiary reference datum of the ferrule 24 into engagement with the corresponding reference datum associated with the port 108 of the measuring fixture 106, i.e., the C datum surface on the ferrule 24 into engagement with the G datum surface associated with the port 108 of the measuring fixture 106 in accordance with the exemplary method 90 described above.

Next, the first clamp mechanism 176 and the second clamp mechanism 178 are coordinated such that the at least one spring arm 190 of the headpiece 182 on the actuator arm 184 of the second clamp mechanism 178 makes the second contact with the ferrule 24. More particularly, the at least one spring arm 190 of the of the second clamp mechanism 178 is configured to engage the rear end face 78 of the ferrule body 68 and impose a clamping force F_{z} on the ferrule body 68 to cause engagement or further engagement between the rear wall 86 of the cavity 80 of the ferrule body 68 and the at least one projection 166 of the engagement region 158 of the interface body 112. Thus, the rear wall 86 of the ferrule body 68 operates as the B datum surface and the at least one projection 166 operates as the E datum surface. In other words, the first clamp mechanism 176 and the second clamp mechanism 178 are coordinated to engage the secondary reference datum of the ferrule 24 into engagement with the corresponding reference datum associated with the port 108 of the measuring fixture 106, i.e., the B datum surface on the ferrule 24 into engagement with the E datum surface associated with the port 108 of the measuring fixture 106 in accordance with the exemplary method 90 described above.

Lastly, the first clamp mechanism 176 and the second clamp mechanism 178 are coordinated such that the first projection 150 on the first leg 146 of the head body 144 of the second flexure element 136 makes the third contact with the ferrule 24. More particularly, the first projection 150 of the second flexure element 136 is configured to engage the bottom surface 72 of the ferrule body 68 and impose a clamping force F_{y} on the ferrule body 68 to cause engagement or further engagement between the top surface 70 of the ferrule body 68 and the second and third shoulders 168, 170 of the engagement region 158 of the interface body 112. Thus, the top surface 70 of the ferrule body 68 operates as the A datum surface and the second and third shoulders 168, 170 of the engagement region 158 of the interface body 112 operates as the D datum surface. In other words, the first clamp mechanism 176 and the second clamp mechanism 178 are coordinated to engage the primary reference datum of the ferrule 24 into engagement with the corresponding reference datum associated with the port 108 of the measuring fixture 106, i.e., the A datum surface on the ferrule 24 into engagement with the D datum surface associated with the port 108 of the measuring fixture 106 in accordance with the exemplary method 90 described above.

Moreover, when the first and second clamp mechanisms 176, 178 are in their closed and extended positions, respectively, the magnitude Mₓ of the clamping force Fₓ is configured to be less than the magnitude M_{z} of the clamping force F_{z}, which is configured to be less than the magnitude M_{y} of the clamping force F_{y}. In other words, the first and second clamp mechanisms 176, 178 are configured to provide the desired levels in the magnitudes Mₓ, M_{z}, M_{y} of the clamping forces Fₓ, F_{z}, F_{y} in accordance with the exemplary method 90 described above. With the ferrule 24 secured within the port 108 of the measuring fixture 106, measuring the end face 56 of the ferrule 24 may commence with increased assurance that the ferrule 24 is positioned and secured at its predetermined location within the port 108 of the measuring fixture 106.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Instead, it should be evident that departures may be made from such details without departing from the scope of the disclosure.

What is claimed is:

1. A method of measuring an end face of a ferrule of a fiber optic connector, the ferrule defining at least two reference datums, one of the at least two reference datums being a primary reference datum and another of the at least two reference datums being a secondary reference datum, the method comprising:
inserting the ferrule in a port of a fixture;
securing the ferrule within the port of the fixture, comprising:
imposing a first clamping force (F₁) on the ferrule to engage the secondary reference datum of the ferrule with a first reference datum associated with the fixture;
subsequently imposing a second clamping force (F₂) on the ferrule to engage the primary reference datum of the ferrule with a second reference datum associated with the fixture; and
measuring the end face of the ferrule while the ferrule is secured to the port of the fixture.

2. The method of claim 1, wherein:
imposing the first clamping force (F₁) on the ferrule includes imposing the first clamping force (F₁) with a first magnitude (M₁); and
imposing the second clamping force (F₂) on the ferrule includes imposing the second clamping force (F₂) with a second magnitude (M₂),
wherein the second magnitude (M₂) is greater than the first magnitude (M₁).

3. The method of claim 1, wherein:
imposing the first clamping force (F₁) on the ferrule further comprises activating a first clamp mechanism;
imposing the second clamping force (F₂) on the ferrule further comprises activating a second clamp mechanism; and
the first clamp mechanism and the second clamp mechanism are separate from each other and independently controlled.

4. The method of claim 1, wherein:
imposing the first clamping force (F₁) on the ferrule further comprises imposing a first spring force on the ferrule; and
imposing the second clamping force (F₂) on the ferrule further comprises imposing a second spring force on the ferrule.

5. The method of claim 1, wherein the at least two reference datums of the ferrule further includes a tertiary reference datum, and wherein the method further comprises:
imposing a third clamping force (F₃) on the ferrule to engage the tertiary reference datum of the ferrule with a third reference datum associated with the fixture.

6. The method of claim 5, wherein imposing the third clamping force (F₃) on the ferrule includes imposing the third clamping force (F₃) on the ferrule prior to imposing the first clamping force (F₁) on the ferrule.

7. The method of claim 5, wherein imposing the third clamping force (F₃) on the ferrule includes imposing the third clamping force (F₃) with a third magnitude (M₃), and wherein the third magnitude (M₃) is less than the first magnitude (M₁).

8. The method of claim 5, wherein imposing the third clamping force (F₃) on the ferrule further comprises activating a third clamp mechanism.

9. The method of claim 5, wherein imposing the second clamping force (F₂) on the ferrule and imposing the third clamping force (F₃) on the ferrule further comprises activating a same clamp mechanism to impose both the second clamping force (F₂) and the third clamping force (F₃) on the ferrule.

10. The method of claim 1, wherein:
the ferrule includes a generally rectangular ferrule body defining a top surface, a bottom surface, opposed side surfaces, a front end face, and a rear end face, the plurality of fiber bores extending between the rear end face and the front end face;
the ferrule further includes a cavity in the top surface of the ferrule body that extends from the front end face toward the rear end face for part of a length of the ferrule, the cavity being open to the front end face of the ferrule body and including opposed side walls and a rear wall, and the cavity extending from the top surface toward the bottom surface for part of a height of the ferrule body,
the top surface of the ferrule body serves as the primary reference datum; and
the rear wall of the cavity in the top surface serves as the secondary reference datum.

11. A fixture for measuring an end face of a ferrule of a fiber optic connector, the ferrule defining at least two reference datums, one of the at least two reference datums being a primary reference datum and another of the at least two reference datums being a secondary reference datum, the fixture comprising:
a fixture port configured to receive the ferrule therein; and
a plurality of clamp mechanisms for clamping the ferrule within the port in a predetermined location, the plurality of clamp mechanisms configured to impose a first clamping force (F₁) on the ferrule to engage the secondary reference datum of the ferrule with a first reference datum associated with the fixture, and subsequently impose a second clamping force (F₂) on the ferrule to engage the primary reference datum of the ferrule with a second reference datum associated with the fixture.

12. The fixture of claim 11, wherein the plurality of clamp mechanisms comprises:
a first clamp mechanism for imposing the first clamping force (F₁) on the ferrule; and
a second clamp mechanism for imposing the second clamping force (F₂) on the ferrule,
wherein the first clamp mechanism and the second clamp mechanism are separate from each other and independently controlled.

13. The fixture of claim 12, wherein the first clamp mechanism comprises:
an actuator arm movable along an actuator axis between an extended position and a retracted position; and
a headpiece connected to an end of the actuator arm,
wherein in the extended position, the headpiece is configured to contact the ferrule and clamp the ferrule to the port of the fixture in the predetermined position, and
wherein in the retracted position, the headpiece is configured to be in non-contact relation with the ferrule.

14. The fixture of claim 11, wherein the fixture includes a processing interface that defines the port, the processing interface comprising:
a processing body defining an aperture; and
a primary flexure element moveably disposed in the aperture,
wherein the port is defined at least in part by the processing body and at least in part by the primary flexure element, and
wherein the second clamp mechanism is operatively connected to the primary flexure element for moving the primary flexure element between an opened position, in which the ferrule is insertable in the port, and a closed position, in which the ferrule is secured in the port.

15. The fixture of claim 14, wherein primary flexure element includes a secondary flexure element, and wherein the secondary flexure element is the portion of the primary flexure element that defines at least part of the port.

16. The fixture of claim 15, wherein the primary flexure element includes a primary spring arm and a primary flexure head connected to the primary spring arm, wherein the secondary flexure element includes a secondary spring arm and a secondary flexure head connected to the secondary spring arm, and wherein secondary flexure head is the portion of the secondary flexure element that defines at least part of the port.

17. The fixture of claim 16, wherein the secondary flexure head comprises:
a first leg having at least one first projection configured to engage with the ferrule; and
a second leg connected to the first leg and having at least one second projection configured to engage with the ferrule.

18. The fixture of claim 14, wherein the processing body includes an engagement region comprising:
a first edge that defines a first shoulder for engaging with the ferrule; and
a second edge that defines at least one projection for engaging with the ferrule.

19. The fixture of claim 11, wherein the at least two reference datums of the ferrule further includes a tertiary reference datum, and wherein the plurality of clamp mechanisms is configured to:
impose the first clamping force (F₁) on the ferrule with a first magnitude (M₁);
impose the second clamping force (F₂) on the ferrule with a second magnitude (M₂) that is greater than the first magnitude (M₁); and
impose a third clamping force (F₃) on the ferrule with a third magnitude (M₃) that is less than the first magnitude (M₁).

20. A method of making a fiber optic cable assembly, comprising:
stripping an end of a fiber optic cable carrying a plurality of optical fibers to expose a length of the optical fibers;
loading one or more components of a fiber optic connector onto the stripped end of the fiber optic cable;
securing the optical fibers to a ferrule of the fiber optic connector, wherein the ferrule defines at least two reference datums, one of the at least two reference datums being a primary reference datum and another of the at least two reference datums being a secondary reference datum;
inserting the ferrule in a port of a fixture;
securing the ferrule within the port of the fixture, comprising:
imposing a first clamping force (F₁) on the ferrule to engage the secondary reference datum of the ferrule with a first reference datum associated with the fixture;
subsequently imposing a second clamping force (F₂) on the ferrule to engage the primary reference datum of the ferrule with a second reference datum associated with the fixture; and
measuring the end face of the ferrule while the ferrule is secured to the port of the fixture.
